(19) United States
(12) Patent Application Publication
(10) Pub. No.: US 2013/0257103 A1
(43) Pub. Date: Oct. 3, 2013

(54) FLOOR STRUCTURE OF A MOTOR VEHICLE BODY

(71) Applicant: GM GLOBAL TECHNOLOGY OPERATIONS LLC, Detroit, MI (US)

(72) Inventors: Udo MILDNER, Limburg (DE); Karsten BOHLE, Bad Schwalbach (DE)

(73) Assignee: GM GLOBAL TECHNOLOGY OPERATIONS LLC, Detroit, MI (US)

(21) Appl. No.: 13/804,516

(22) Filed: Mar. 14, 2013

(30) Foreign Application Priority Data
Mar. 29, 2012 (DE) 10 2012 006 528.0

(51) Int. Cl. B62D 25/20

(52) U.S. Cl. CPC B62D 25/20
USPC 296/193.07

(57) ABSTRACT

A floor structure of a motor vehicle body having a floor panel and having a support structure provided below the floor panel is provided. The floor structure includes two longitudinal structures spaced from one another in vehicle transverse direction, which are interconnected via at least one cross member structure extending in vehicle transverse direction. In an intermediate space between the floor panel and the cross member structure at least one reinforcement element of plastic is arranged.

### CROSS-REFERENCE TO RELATED APPLICATION

This application claims priority to German Patent Application No. 10 2012 006 528.0, filed Mar. 29, 2012, which is incorporated herein by reference in its entirety.

### TECHNICAL FIELD

The technical field relates to the floor structure of a motor vehicle body having a floor panel and a support structure provided below the floor panel, which is formed in particular as seat support structure for fastening vehicle seats.

### BACKGROUND

In the construction of motor vehicle bodies there exists various concepts for implementing a floor structure to be provided in particular in the region of a passenger cell of the motor vehicle. Known floor structures typically have a center tunnel extending almost over the entire length of the passenger cell and over the middle of the floor structure and seat cross members arranged on the top of a floor panel and provided separately for fastening vehicle seats. The actual floor panel in this case is mostly formed of multiple parts and typically adjoins the center tunnel approximately laterally with individual floor panel segments.

A cross member for a motor vehicle with a holding device is also known for example from DE 10 2006 001 348 A1, wherein on a cross member basic part at least one holder consisting of another material is attached. Said holder serves for attaching elements to the cross member basic part. The cross member basic part can furthermore comprise a hollow space for conducting a medium, wherein in the hollow space an air duct can be introduced.

The arrangement of an air duct in a cross or side member to be provided for example below a floor panel, for example for supplying the rear vehicle seats with fresh air or with air-conditioned air requires, however, that suitable air ducting systems of a heating and/or air-conditioning system have to be provided in the front foot well of the vehicle for example from the center tunnel to the outside to a sill structure. Such an air ducting course however requires a lowering of the floor level so that a safe and adequate accessibility to the pedals in the foot well can be ensured.

In addition, other objects, desirable features and characteristics will become apparent from the subsequent summary and detailed description, and the appended claims, taken in conjunction with the accompanying drawings and this background.

### SUMMARY

The present disclosure provides a floor structure of a motor vehicle body that is improved with respect to its bending and structural stiffness. This should generally be accompanied by a weight and/or component reduction and furthermore make possible a simple and cost-effective production. In addition, the floor structure should additionally contribute to increasing possible vibration natural frequencies of the motor vehicle body and counteract resonance and vibration effects that occur during the operation of the vehicle in a damping manner. Furthermore, the present disclosure provides an air ducting system that is improved and can be flexibly adapted to existing installation space, in particular for the rear vehicle seats.

The floor structure of a motor vehicle body provided accordingly comprises a floor panel and a support structure provided below the floor panel. Here, the support structure typically comprises two longitudinal structures spaced from one another in vehicle transverse direction (y), which are interconnected via at least one cross member structure extending in vehicle transverse direction (y). The cross member structure in this case extends below the floor panel. Since the floor panel, too, generally comes to lie laterally adjoining the longitudinal structure or above the latter, an intermediate space is created between the cross member structure and the floor panel. In this intermediate space between floor panel and cross member structure at least one reinforcement element of plastic is arranged, which can provide an additional structural reinforcement and stiffening of the floor panel and of the cross member structure, therefore the entire floor structure.

The use of a reinforcement element produced from plastic or comprising plastic can contribute to the reduction of the vehicle weight. Owing to the fact that the plastic reinforcement element provides a load-bearing or load-transmitting function, remaining body or floor structure components produced from sheet metal can be formed in a more thin-walled and thus weight-saving manner if required. The weight saving on the part of the metal components in this case is advantageously greater than the additional weight brought about by the reinforcement element. The reinforcement element is generally formed as an injection molded component and can be adapted almost to any given installation dimensions that are available in the intermediate space between floor panel and cross member structure.

The reinforcement element typically comprises a thermoplastic such as for example polypropylene (PP) and/or polyamide (PA), which if required can be provided with a fiber reinforcement at least in portions. It is generally also conceivable that the reinforcement element comprises high-strength plastics or fibers. Thus, the reinforcement element can also be produced completely or only in regions for example from carbon fibers or carbon or comprise corresponding carbon fiber or carbon components.

According to one exemplary embodiment, the reinforcement element is connected to the floor panel. Here, a generally large-area connection is provided, so that the reinforcement element can generally structurally reinforce and stiffen the entire floor panel, but at least individual area portions thereof.

According to one embodiment, the reinforcement element is connected to the cross member structure provided below the floor panel. Here, too, a generally large-area connection of cross member structure and reinforcement element if possible extending over the entire area of the cross member structure is provided.

Advantageously, the reinforcement element is structurally connected to both floor structure components forming the intermediate space, namely the floor panel and the cross member structure located below, so that the reinforcement element can structurally reinforce and stiffen both the floor panel as well as the cross member structure each separately as well as their connection among one another. From this it follows that individual area portions of floor panel and cross member structure arranged for example located on top of one another for example in vehicle vertical direction (z) or overlapping in regions can be directly interconnected by means of the reinforcement element arranged in between and supported with respect to one another or against one another.

According to one embodiment, the reinforcement element comprises a rib-like structure having a plurality of reinforcement ribs at least in regions. The reinforcement ribs in this case adjoin both the floor panel as well as the cross member structure. It is hereby provided in particular that the individual reinforcement ribs along all reinforcement ribs that come in contact position with the floor panel and/or with the cross member structure can be structurally connected or are connected directly to the floor panel and/or to the cross member structure.

Owing to the fact that along all, but at least along some reinforcement ribs a direct connection of floor panel and/or cross member structure to the respective reinforcement ribs is provided, a multiple strut-like direct connection between the floor panel and the cross member structure located below is obtained via the reinforcement element.

According to one embodiment, at least some reinforcement ribs of the reinforcement element comprise a support flange at their end portions facing the floor panel and/or the cross member structure. The support flange in this case extends corresponding to the orientation and shaping of the respective adjoining area portion of the floor panel and/or of the cross member structure. By way of the support flange or via a plurality of support flange portions generally provided located opposite on the reinforcement ribs, mechanical forces introduced into the floor structure can be discharged or transmitted from the floor panel into the reinforcement ribs and finally into the cross member structure located below or vice versa.

Advantageously, a plurality of differently oriented reinforcement ribs are provided on the reinforcement element. These can, based on the vehicle geometry, extend for example in vehicle longitudinal direction (x), in vehicle transverse direction (y) as well as also transversely thereto.

The individual reinforcement ribs can be arranged regularly as well as equidistantly to one another. They can have a rectangular or square lattice structure as well as comprise any triangular as well as hexagonal or pentagonal structure and areal structures, which are matched to the respective space of installation and the mechanical loads that are typically prevalent there and are suitably adjusted to these.

According to one exemplary embodiment, at least some of the reinforcement ribs are connected in rib longitudinal direction to the floor panel and/or to cross member structure in a force-fitting manner. Possible force-fitting connection and joining techniques in this case are in particular a gluing of the reinforcement ribs to the adjoining sheet metal components, the floor panel and/or cross member structure. Other joining techniques, such as for example a laser or ultrasound welding can also be provided, wherein in particular the portions of the reinforcement element produced from plastic coming into contact position with the adjoining metal components can be thermally excited and melted at least in regions.

In one exemplary embodiment, the force-fitting connection of the reinforcement element to the floor panel, the cross member structure and/or to the longitudinal structure using a suitable thermally activatable adhesive takes place. Here, the adhesive can be provided in particular on the support flanges of the reinforcement ribs of the reinforcement element facing the adjoining floor structure components.

Since the floor structure for the entire motor vehicle body typically is subjected to a painting and subsequent drying process and correspondingly subjected to the effect of heat, it can be provided in particular that the thermally activatable adhesive for example is only thermally heated and accordingly activated in the drying process following a painting of the body. The thermally activatable adhesive expands in particular under the effect of heat so that generally along the entire support flange provided with a corresponding adhesive one or a plurality of reinforcement ribs can form a force-fitting or bonded material connection to the floor panel adjoining thereon or to the cross member structure.

For preassembly purposes, the reinforcement element can be fixed in position on the cross member structure and/or on the longitudinal structure with respect to its position on the floor panel by means of individual form-fitting elements such as for example engagement elements or clips. Here it is conceivable, furthermore, that the floor panel, the cross member structure and/or the longitudinal structure of the vehicle body comprise individual or a plurality of fastening points or elements, which interact with corresponding fastening points or elements of the reinforcement element formed as insert corresponding thereto for the position fixing of said reinforcement element. Thus, a continuation projecting upwards or a corresponding fastening dome can for example be formed on the reinforcement element, in or on which the reinforcement element can be inserted or placed.

The thermally activatable adhesive is advantageously already arranged in a customized manner on the end portions of relevant reinforcement ribs of the reinforcement element facing the floor panel, the cross member structure and/or longitudinal structure, so that in the body-in-white construction a suitably pre-customized reinforcement element merely has to be positioned in a region on the cross member structure provided for this purpose or in the intermediate space between floor panel and cross member structure and fixed in position in the predetermined position at least up to the activation of the adhesive.

According to one exemplary embodiment, the reinforcement element comprises at least one air-conducting duct. In this respect, the reinforcement element fulfills a further function in addition to its structurally reinforcing effect by providing an air-conducting duct for an air ducting system, in particular for the vehicle rear, for example for the seats of a second or third row of seats of a motor vehicle.

The air-conducting duct in this case can run below the floor panel, in particular below a seat connection portion of the floor panel. An air ducting to be implemented in a side sill or a lateral side member can therefore be advantageously omitted.

According to one exemplary embodiment, the at least one air-conducting duct of the reinforcement element comprises a substantially U or V-profile-like cross section, which is sealingly closed off by an adjoining portion of the floor panel or of the cross member structure. With respect to this it is advantageous when the reinforcement element following the course of the duct directly adjoining a duct wall is provided with a thermally activatable adhesive, so that during the course of the activation of the adhesive the air-conducting duct can be sealed against the sheet metal component closing off the duct for example against the floor panel or the cross member structure.

Here, the duct itself can be divided into a plurality of for example parallel-running and branching-off part channels, wherein individual intermediate wall portions between adjoining ducts can be structurally connected to the adjoining floor structure components, for example the floor panel and/or the cross member structure likewise in the transition between adjoining channels. In this regard, the duct portion can equally contribute to the structural reinforcement of the floor structure, thereby of the entire motor vehicle body.

According to one exemplary embodiment, the at least one duct portion comprises at least one air inlet opening facing upwards to the floor panel and at least one air outlet opening spaced therefrom in vehicle longitudinal direction (x). The air outlet opening can likewise be facing the floor panel and accordingly, be formed or oriented facing upwards. The air inlet and/or outlet openings of the duct portions facing the floor panel are generally provided with a seal, which can be provided by the thermally activatable adhesive as already described before.

In this regard, the reinforcement element can comprise a sealing structure about the air inlet and air outlet opening facing the floor panel which encloses the respective opening and is formed by means of thermally activatable adhesive. Alternatively, conventional seals, for example in the form of sealing rings can also be provided in the region of the air inlet and/or air outlets. For connecting the duct portion, suitable through-openings corresponding to the air inlet opening and to the air outlet opening and which come to lie with these in an aligned manner are provided in the floor panel. By way of those through-openings, the duct portion located below can be fluidically connected to further air-conducting components.

According to one exemplary embodiment, the air inlet openings are provided approximately in the middle with respect to the vehicle transverse direction (y) between the longitudinal structures of the floor structure. The air outlet openings are each generally arranged laterally offset to the outside, so that an air supply provided approximately in the middle of the vehicle can be directed in vehicle transverse direction to the rear vehicle seats located outside in each case. In this regard, the duct portion also provides a distribution of supplied air in vehicle transverse direction (y).

Thus, the reinforcement element can provide a y-like branch of an air-conducting duct. Furthermore, a single air inlet opening can be provided for example on the air inlet side, which downstream of the duct portion branches out into a plurality of part duct portions, which extend to the air outlet openings each located on the left and right outside and provided offset to the air inlet opening in vehicle longitudinal direction (x).

Besides a branching-off duct structure, however, it is also conceivable that at least two air inlet openings are provided, which, hermetically separated from one another, each lead to one or to a plurality of air outlet openings. The respective duct portion in this case can for example have an L or arc-shaped geometry in the plane formed by vehicle longitudinal direction (x) and vehicle transverse direction (y).

According to one exemplary embodiment, the floor panel and the transverse structure based on the vehicle vertical axis (z) adjoin the lateral longitudinal structure substantially extending in vehicle longitudinal direction (x) spaced from one another. The reinforcement element located in between hereby supports itself in the longitudinal structure with a lateral continuation extending in vehicle transverse direction (y). As already described previously with reference to the reinforcement ribs, the lateral continuation can also comprise a flange on its free end matched to the alignment of the adjoining longitudinal structure, which can likewise be structurally connected to the longitudinal structure along its entire longitudinal extension by means of a thermally activatable adhesive.

Hereby it is conceivable, furthermore, that the reinforcement element comprises at least one air-conducting duct portion which leads to a lateral opening of the floor panel arranged above or which extends to lateral openings of a side cheek of a seat connection portion of the floor panel in order to achieve in particular an air distribution via the B-pillar adjoining here. By means of this, an air distribution in vehicle vertical direction (z) for example to the rear passengers can also be brought about. The air-conducting duct portion extending to the outside, approximately in vehicle transverse direction (y) in this case can in particular extend in the lateral continuation of the reinforcement element and/or be formed through an interaction with the components adjoining in vehicle vertical direction, for example the floor panel or the cross member structure.

According to one embodiment, the floor panel comprises a seat connection portion which with respect to a front foot well portion is formed elevated. The cross member structure, which is provided below the floor panel, hereby advantageously comprises a one-piece areal structure to the total area of the seat connection portion. The seat connection portion of the floor panel and the cross member structure having a similar or largely identical geometry that is comparable in terms of area in principle form a double floor panel, wherein the seat connection portion forms a kind of upper shell and the cross member structure a kind of lower shell.

Advantageously it is hereby provided in particular when the cross member structure and the seat connection portion located above in vehicle vertical direction (z) are substantially arranged in an overlapping or covering manner based on a vehicle plane extending in vehicle longitudinal direction (x) and vehicle transverse direction (y).

The seat connection portion, which is generally formed as an integral part of the floor panel, can be structurally reinforced through the cross member structure located directly below. In that the cross member structure directly interconnecting the longitudinal structures comprises at least one extension in vehicle longitudinal direction (x), which corresponds to the length of a seat connection, a particularly torsionally stiff and rigid transverse connection of the longitudinal structures can be provided. The lengths (x)-to-width (y)-ratio of the cross member structure in this case can amount to between about 1:10 and about 1:1.5, generally between about 1:5 and about 1:2.

According to one exemplary embodiment, the cross member structure comprises a shell-like and predominantly closed areal structure. The cross member structure can furthermore be largely formed flat at least in regions. In particular in connection regions to adjoining components of a motor vehicle body and/or their floor structure, however, geometrical configurations and profile geometries adapted to the respective connection portions are advantageous. The entire cross member structure in this case can be formed as individual part, which is cut out or punched out of a sheet metal cutting and for example brought into a predetermined geometrical form by means of a forming operation, for example by means of stamping.

In particular for space reasons or for reasons of weight saving, the areal structure forming the cross member structure can also comprise individual clearances or through-openings. These can be formed in particular for receiving further function components of a motor vehicle, such as for example accommodating a fuel tank, a vehicle battery, a fuel pump or other components generally to be provided in the exterior space of the motor vehicle.

According to one exemplary embodiment, the cross member structure is structurally connected to the longitudinal structures located opposite along its entire extension in vehicle longitudinal direction (x). Corresponding to the comparatively long extension in vehicle longitudinal direction of the cross member structure, a high torsional stiffness and rigidity of the floor structure can be provided in the seat connection region through the connection to the longitudinal structures located opposite.

Here it is provided, in particular, that the cross member structure supports itself over its entire longitudinal extension at least once-off or multiple times on the longitudinal structure with at least one connection flange and along a support contour formed thereby is generally non-releasably connected to the respective longitudinal structure either intermittently or continuously, for example along a joining seam. A load-transmitting structural connection of the cross member structure to the longitudinal structures located opposite can be achieved here by means of welding, riveting and/or gluing but also by means of penetration joining.

The comparatively large-area connection of the cross member structure can furthermore contribute to improving the dimensional accuracy of the body structure. Through the comparatively long joining location between cross member structure and longitudinal structure corresponding to the longitudinal extension of the cross member structure, the natural vibration behavior of the floor structure, in particular its bending frequency, can be advantageously changed, in particular increased, so that the frequency range can be shifted from natural frequencies that are invariably created during the operation of the vehicle to advantageously higher frequency ranges that can be perceived by the vehicle occupants to a lesser degree.

In one embodiment, the longitudinal structures comprise an inner sill profile projecting in vehicle transverse direction (x) to the inside and a side member profile connected therewith. The side member profile in this case can have an in particular L-shaped form and, with a leg approximately projecting horizontally to the outside, adjoin the inner sill profile projecting to the inside from the inside and be structurally connected to the latter there. A further leg of the L-shaped side member profile in this case can project from an end of the horizontally oriented leg of the side member profile located opposite upwards in vehicle vertical direction (z).

It is advantageous, if the cross member structure comprises a lateral connecting slope substantially closing off the side member profile, with which the cross member structure bears on the side member profile. To this extent, a connecting slope of the cross member structure projecting in vehicle transverse direction to the outside and obliquely downwards can act as closing plate for the L-shaped side member profile that is formed open towards the top.

According to one exemplary embodiment, the reinforcement element formed in one piece of multiple pieces almost completely fills out the intermediate space formed by the seat connection portion of the floor panel and the cross member structure located below. The hollow or intermediate space formed between seat connection portion and cross member structure can thus be stiffened with a comparatively light plastic material for structurally reinforcing the motor vehicle floor structure. The generally multiple, materially bonded and non-releasable connecting of the reinforcing element to adjoining sheet metal or metal component so of the floor structure, in particular to the seat connection portion, the cross member structure and/or to the longitudinal structure comprising a side sill and/or a side member profile, can furthermore improve the natural frequency and vibration behavior of the floor structure.

According to one exemplary embodiment, the seat connection portion provided adjoining the foot well portion of the floor panel is formed free of a center tunnel. The center tunnel-free configuration in this case can be achieved in particular through the height offset between seat connection portion and foot well portion of the floor panel. Foot well portion and seat connection portion in this case can also be configured unitarily as a continuous floor panel, but alternatively also in multiple parts, as an assembled floor panel.

Through the configuration of the seat connection portion that is offset or elevated in vehicle vertical direction with respect to the foot well portion, additional installation space can be provided below the seat connection portion, which is suitable in particular for stowing additional vehicle components such as for example a fuel tank or one or a plurality of vehicle batteries or accumulators. The floor panel that is formed elevated in the region of the seat connection is suitable in this case in particular for so-called multipurpose vehicles (MPV) or for sport utility vehicles (SUV), which due to their design have a relatively large distance between a floor structure and the floor line or the tire contact plane anyway.

According to various aspects, a motor vehicle body is also provided which has a floor structure described before.

Furthermore, according to various aspects, a motor vehicle having a floor structure described before is provided.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 is a perspective representation of a floor structure before the assembly with a floor panel;

FIG. 2 is an isolated representation of two reinforcement elements formed in mirror-image fashion relative to one another;

FIG. 3 is a perspective representation of the reinforcement elements in assembly position on a cross member structure;

FIG. 4 is an isolated perspective representation of a seat connection portion of the floor panel;

FIG. 5 is a perspective representation of the floor structure in final assembly configuration;

FIG. 6 is a cross-sectional representation along A-A according to FIG. 5;

FIG. 7 is a cross-sectional representation along B-B according to FIG. 5;

FIG. 8 is an enlarged representation of the cross section according to FIG. 7 in the region of an air-conducting duct portion; and

FIG. 9 is a cross-section along C-C according to FIG. 5, which extends through one of the air-conducting ducts of the reinforcement element.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

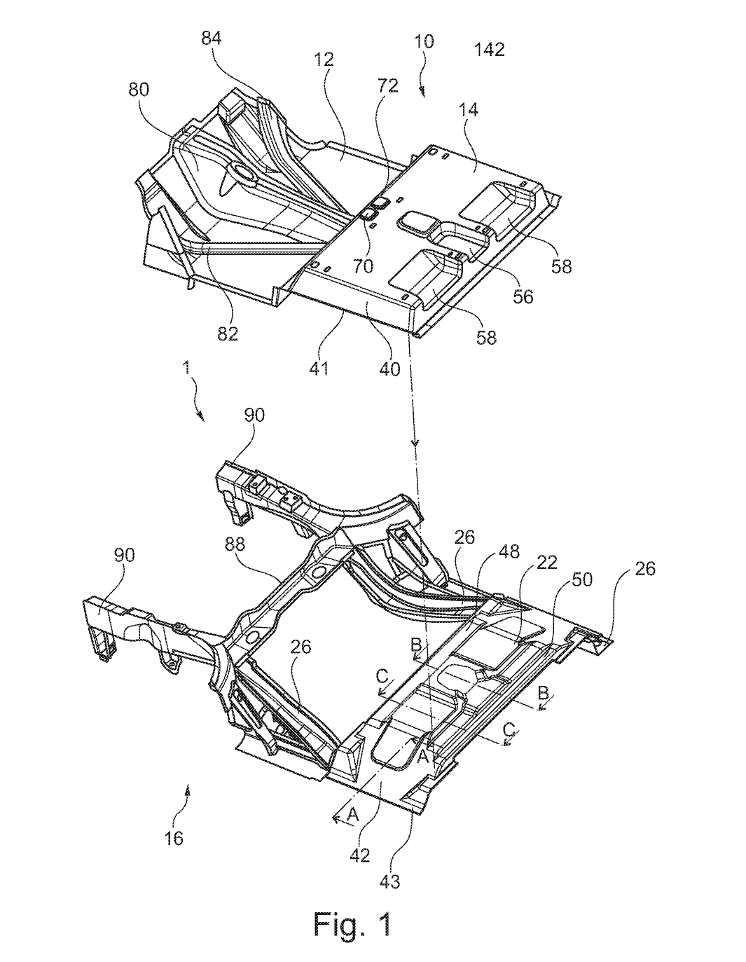

FIG. 1 shows a cross member structure 22 formed as a real structure, which can be arranged between two longitudinal structures 18, 20 of a support structure 16 substantially extending in vehicle longitudinal direction (x). The shown support structure 16 comprises two front side members 90, 92, which located in front of a passenger cell of a motor vehicle not explicitly shown here later on are structurally interconnected via a front wall cross member 88 in vehicle transverse direction (y).

Starting out from the front wall cross member 88, two lateral side member profiles 26 extend to the back, opposite to the travelling direction 2 to the motor vehicle. The cross member structure 22 has a shell-like and wide-surface configuration and comes to lie above the side member profile 26 with approximately L-shaped configuration.

The cross member structure 22 which is constructed comparatively wide in vehicle longitudinal direction (x) forms a ladder or lattice-like support structure 16 with the front wall cross member 88 and the lateral side member profiles 26, which in particular, because of the dimensioning and the geometrical configuration of the cross member structure 22, provides for a high torsional stiffness.

As is shown in the cross section according to FIG. 7, the cross member structure 22 formed as sheet metal shell comprises a connecting slope 42 each projecting to the outside in vehicle transverse direction (y), which in a final assembly configuration, acts as a kind of closing plate for the side member profile 26 which is approximately L-shaped in cross section. Furthermore, the cross member structure 22 comprises a flange 43 at their lateral edges located in vehicle transverse direction (y), by means of which the connecting slope 42 can be fastened to a profile portion 29 of an inner sill profile 24 of the longitudinal structure 18, 20 over its entire extension in vehicle longitudinal direction (x).

Advantageously, the flange 43 hereby adjoins a lower leg 30 of the inner sill profile 24, where it is structurally connected to the inner sill profile 24. For establishing a connection, for example a spot weld, a plurality of through-openings spaced from one another in vehicle longitudinal direction (x) but which are not explicitly shown are provided for this purpose in a lower leg 36 of the side member profile 26, through which a welding tool can be passed for forming one or a plurality of spot welds.

With its lower leg 36 and a flange 37 provided thereon and projecting to the outside, the side member profile 26 adjoins a leg 32 of the inner sill profile 24 projecting to the inside where it is generally structurally connected, in particular welded to the latter.

In the cross section according to FIG. 7, merely the inner sill profile 24 is shown here, which can be connected to a corresponding outer sill profile which is not shown here for forming a side sill by means of an upper flange 27 and lower flange 33.

Starting out from the lower leg 32 projecting to the inside, the side member profile 26 extends to the inside, wherein a leg 34 of the side member profile 26 projecting upwards in vehicle vertical direction (z) comprises a flange 35 adapted to the profile of the connecting slope 42 at its upper end portion. The cross member structure 22 with its connecting slope 42 supports itself on this flange 35.

Except for possible through-openings for a welding tool, for example, the side member profile 26 together with the connecting slope 42 and with a leg 30 of the inner sill profile 24 adjoining thereon and with a profile portion 31 additionally adjoining thereon, forms a substantially closed hollow profile extending in vehicle longitudinal direction (x).

The shell-like cross member structure 22 shown in FIG. 1, serves for an elevated seat connection and relocates the floor panel 10 of the floor structure with respect to a front foot well portion 12 upwards at least in regions. Furthermore, the cross member structure 22 makes available a torsionally stiff and rigid connection of the lateral longitudinal structures 18, 20, so that in particular the lateral side member profiles 26 together with the front wall cross member 88 and with the cross member structure 22 make available a ladder or lattice-type support structure 16.

In particular through the comparatively long configuration of the cross member structure 22 in vehicle longitudinal direction (x) extending over an entire seat connection portion 14, a particularly stable and dimensionally accurate connection of the longitudinal structures 18, 20 located opposite in vehicle transverse direction (y) can be provided.

The floor panel 10 shown in FIGS. 1, 4 and 5 in different perspective representations comprises a front foot well portion 12 and a seat connection portion 14 which is formed elevated compared to this. The foot well portion 12 and the seat connection portion 14 in this case can be configured in one piece. While in the foot well portion 12 a center tunnel portion 80 or a separate center tunnel is provided, the seat connection portion 14 adjoining thereon against the travelling direction 2 can be formed largely free of a center tunnel because of its elevated position.

Through the position of the seat connection portion 14 lifted upwards, the vehicle components provided below the center tunnel portion 80 can be stowed below without problem.

Independently of this, the foot well portion 12 furthermore comprises two reinforcement profiles 82, 84 each obliquely extending from the center tunnel portion 80 to the outside and to the front, which have a substantially top-hat profile like contour and which are closed off by the foot well portion 12 located below subject to forming a hollow profile. Facing the center tunnel portion 80, the reinforcement profiles 82, 84 approximately adjoin the transition region to the seat connection portion 14 located higher up.

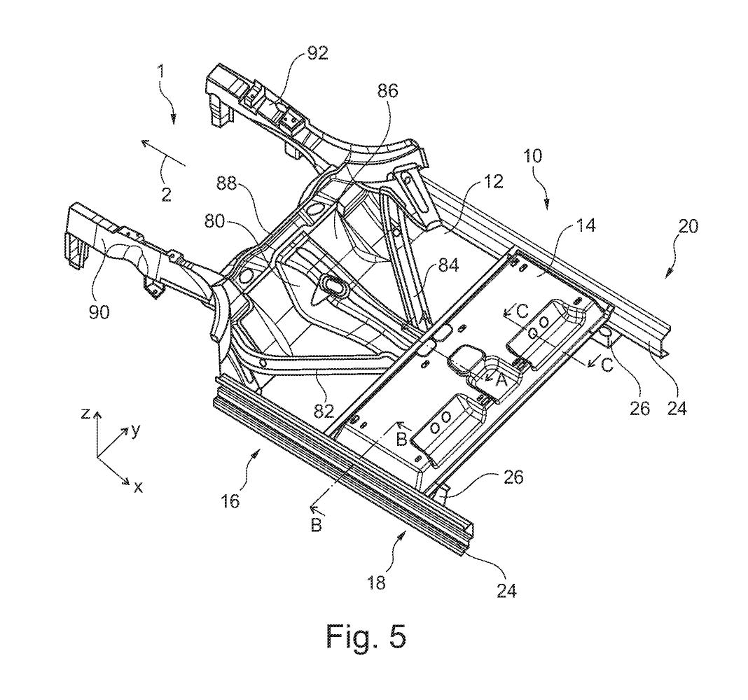

FIGS. 1 and 5 furthermore show the generally one-piece transition of the foot well portion 12 substantially extending horizontally in a front wall portion 86 rising to the front and up. Comparable to the geometrical configuration of the cross member structure 22, the seat connection portion 14 of the floor panel 10 located above also has a shell-like configuration in the form of a predominantly closed areal structure.

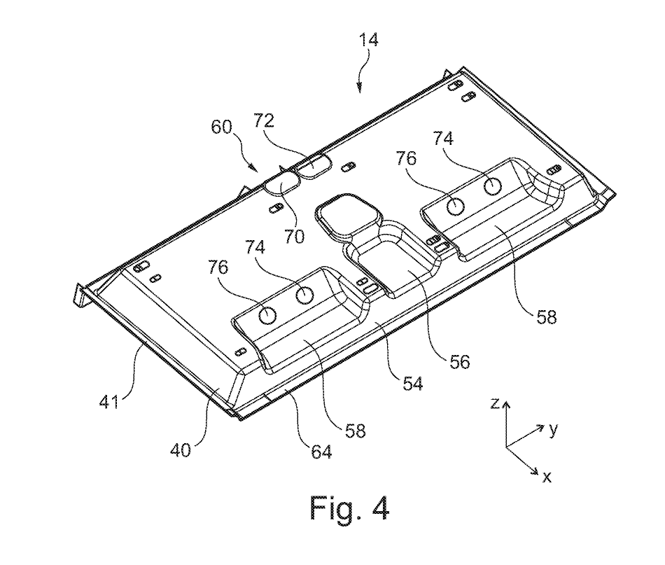

The seat connection portion 14 which is perspectively shown in particular in FIG. 4, comprises various troughs 56, 58 at its rear end, and side cheeks 40 obliquely propping downwards on its lateral edges located in vehicle transverse direction (y).

An approximately linearly formed flange 41 in vehicle longitudinal direction (x) follows each of the cheeks 40, by means of which the seat connection portion 14, as shown in FIG. 7, can be connected to an upper leg 28 of the inner sill profile 24 which is correspondingly formed thereto. The seat connection portion 14 and the cross member structure 22 located below can thus enclose a profile portion 29 of the inner sill profile 24 projecting to the inside from the top and from the bottom, correspondingly in case or in regions engage about the profile portion 29.

In this regard, a double support on the inner sill profile 24 can be achieved, which is also supports itself from the top as well as from the bottom against the profile portion 29 of the inner sill profile 24 projecting to the inside. The torsional and structural stiffness of the floor structure 1 as well as of the entire motor vehicle body can be advantageously increased through this. Furthermore, by using comparatively large-area individual parts, the number of installed parts can be reduced while simultaneously reducing the assembly effort.

The seat connection portion 14 furthermore comprises a cheek 54 with a flange 64 and its rear end, while located opposite, on an end portion of the seat connection portion 14 located in travelling direction 2, a stepped, two-piece cheek arrangement, as shown in FIG. 9, is provided. There it is evident that an upper area portion of the seat connection portion 14 substantially formed flat merges, facing forwards in travelling direction 2, into a cheek 52 corresponding to the lateral cheeks 40.

Approximately at the height of the lateral flange 41, however, a shoulder 55 projecting forward extends at the lower end of the cheek 52, which in turn merges into a cheek portion 53 approximately extending perpendicularly downwards. At the lower end of the cheek portion 53, a further lower flange 66 approximately extending horizontally is finally formed, which with a multiple-part configuration of the floor panel 10 can be connected to the front foot well portion 12 or which with a one-piece configuration of the floor panel 10, is formed as integral part of the front foot well portion 12.

As is merely indicated in FIG. 4, the lower cheek 53 is penetrated by a mounting 60 for the center tunnel portion 80. The lower cheek 53 can thus be formed in two parts.

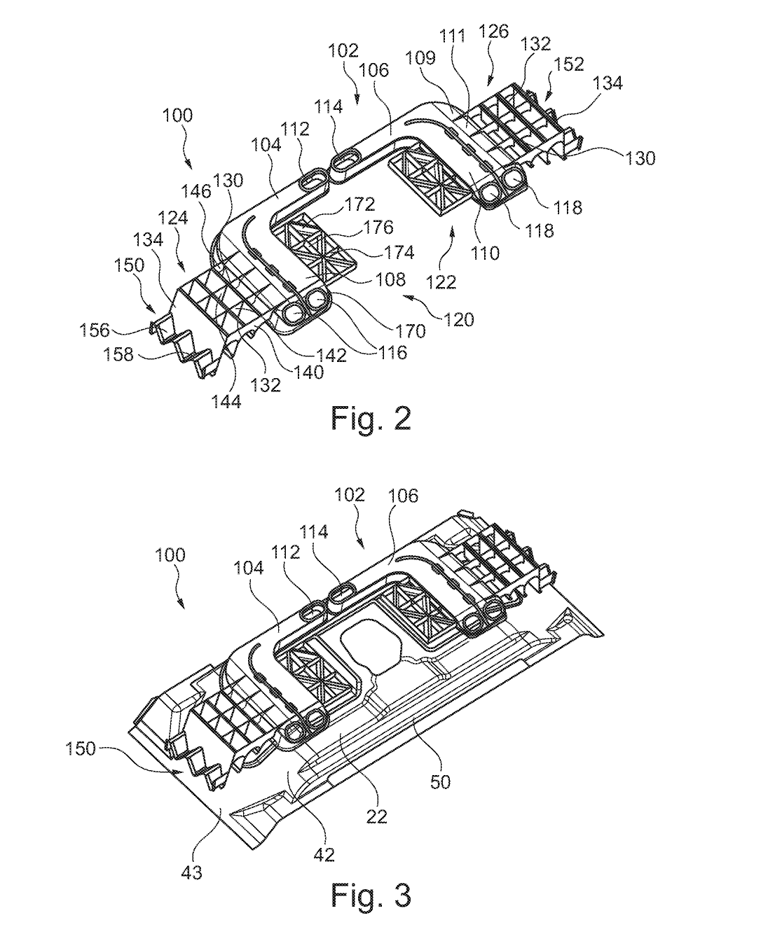

The reinforcement element 100, 102 shown in FIG. 2 in duplicate embodiment in mirror-image fashion relative to one another is produced from plastic and comprises a duct portion 104, 106 each extending approximately in vehicle transverse direction (y), which in a transition region formed arc-like is divided into two duct portions 108, 109 and 110, 111 respectively which approximately extend in vehicle longitudinal direction (x). On the end facing away from the travelling direction 2 of the motor vehicle, the duct portions 108, 109, 110, 111 each have an air outlet opening 116, 118, which are provided with a circumferential seal 170 generally provided by an adhesive.

The outlets 116, 118 in this case generally come to lie approximately overlapping the through-openings 74, 76 of two lateral troughs 58 of the seat connection portion 14 of the floor panel 10 located above. The duct portions 104, 106 located in front in travelling direction and extending in vehicle transverse direction (y) by contrast comprise inlet openings 112, 114 directed upwards, which come to lie below through-openings 70, 72 of the seat connection portion 14 corresponding therewith, which are approximately arranged in the middle between the lateral longitudinal structures 18, 20.

In addition to the duct portions 104, 106, 108, 109, 110, 111 formed approximately L-shaped, the reinforcement element 100 shown in FIG. 2 on the left comprises a reinforcement portion 120 running from the inside duct portion 108 in longitudinal direction projecting inwards, while the reinforcement element 102 provided opposite comprises an inner reinforcement portion 122 which projects from the inner channel duct 110 to the inside and which is largely formed in mirror-image fashion thereto.

As is exemplarily shown by means of the left inner reinforcement portion 120, various webs 172, 174, 176 can be formed in the region of the reinforcement portions 120, 122, which, crosswise or subjected to forming various rectangular, triangular or lattice structures, can develop a structure-reinforcing effect. On the outside of the respective outer duct portion 109, 111 located in vehicle transverse direction (y), outer reinforcement portions 124, 126 are provided. Those reinforcement portions 124, 126 have a lattice or honeycomb-like areal structure, which with respect to its geometrical extension and configuration is adapted to the intermediate space 101 formed by cross member structure 22 and seat connection portion 14.

Thus, the outer reinforcement portion 124 comprises a plurality of reinforcement ribs 130, 132, 134 formed as longitudinal webs which run approximately equidistantly and parallel to one another, which among themselves, likewise via reinforcement ribs 140, 142, 144, 146 arranged approximately equidistantly but perpendicularly therefore and each running vehicle transverse direction (y) and formed as transverse webs, are connected to one another.

On the side of the outer reinforcement portion 124 projecting to the outside in vehicle transverse direction (y) or outside on its outer reinforcement rib 134, a continuation 150, 152 extending in vehicle longitudinal direction (x) and approximately zig-zag like in vehicle vertical direction (z) is provided, which, as shown in cross section according to FIG. 7, supports itself on the profile portion 29 of the inner sill profile 24 projecting to the inside with a flange 154 provided at its free end.

The reinforcement element 102 located opposite approximately assigned to the right side of the vehicle, has a largely mirror-symmetrical configuration of reinforcement ribs 130, 132, 134, 140, 142, 144, 146 in the region of its outer reinforcement portion 126. Here, too, a continuation 152 projecting to the outside is provided on the outer reinforcement rib 134, which in a manner that is comparable to that of the continuation 150 on the longitudinal structure 20, is supported in particular on an inner sill profile provided there, which in this case is not explicitly shown.

The continuations 150, 152 shown in FIG. 2 comprise, in this respect, based on the travelling direction (2), falling and rising flanks 156, 158 arranged alternatingly.

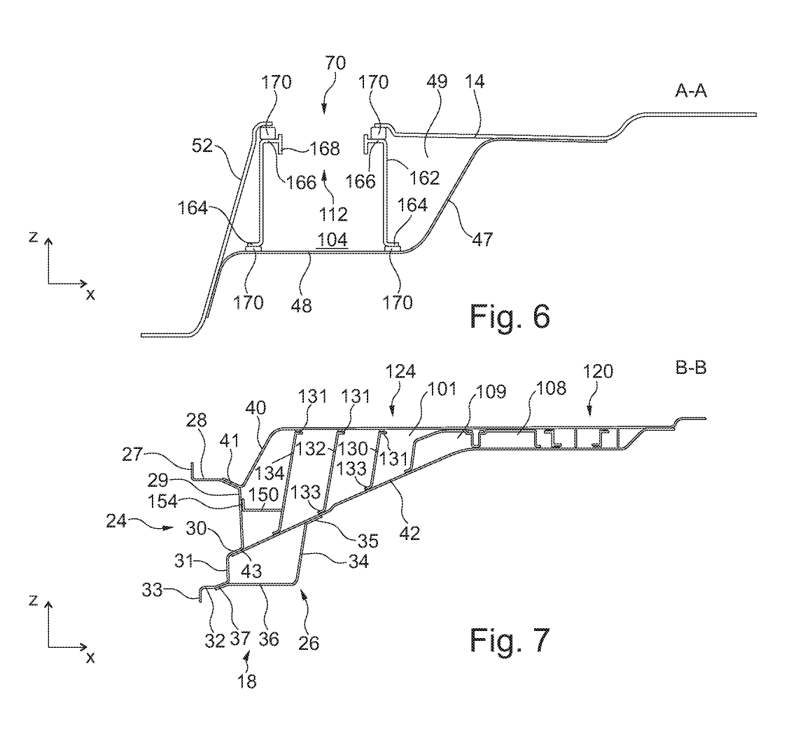

In the cross section according to FIG. 6 it is evident that the duct portion 104 of the reinforcement element 100 running substantially in vehicle transverse direction (y) adjoining the inlet opening 112 comprises a flange 166 provided with a substantially T-shaped profile portion 168, wherein opposite flange portions 166 projecting against the inlet opening 112 merge into side walls 160, 162 located opposite and forming the duct portion 104.

On the lower end of the side walls 160, 162, a flange 164 each projecting to the outside from the interior of the duct portion 104 is provided. On the upper flange portion 166 as well as on the lower flange 164, a seal 170 each is arranged, which can be generally formed by a thermally activatable adhesive. The seal 170 or the corresponding adhesive can be arranged already preassembled or pre-customized on the reinforcement element 100 or on its duct portion 104.

The upper seal 170, which is provided on the upper flange 166, comes to lie in the final assembly configuration shown in FIG. 6, below an opening rim of the through-opening 70 provided in the seat connection portion 14. By means of that seal 170, the through or inlet openings 170, 112 substantially located aligned with respect to one another can be sealed relative to one another.

A hollow profile portion 49, as is formed by a transverse profile portion 48 and a cheek 47 of the cross member structure 22 adjoining thereon and by a front cheek 52 of the floor panel 10 and of the seat connection portion 14, can be sealed hermetically or in a gas and liquid-tight manner relative to the air-conducting duct portion 104 and suitably closed off.

In the cross section according to FIG. 7 it is shown, furthermore, that the reinforcement element 100 with its reinforcement ribs (130, 132, 134) extending approximately in vehicle longitudinal direction (x) supports itself each downwards on a connecting slope 42 of the cross member structure 22 and upwards on the seat connection portion 14 of the floor panel 10 which is largely formed flat.

Towards the top, facing the seat connection portion 14, the reinforcement ribs 130, 132, 134 each have a flange 131 following the contour and the profile of the seat connection portion 14. Here, starting out from the respective reinforcement rib 130, 132, 134, that flange 131 in each case extends to the inside, towards the vehicle middle. Located opposite facing the connecting slope 42, the reinforcement ribs 130, 132, 134 each have a flange 133 projecting to the outside following the profile of the connecting slope 42.

On the upper flanges 131 as well as on the lower flanges 133, generally a thermally activatable adhesive is provided, which can be activated in particular during the course of drying process connected downstream of a painting process.

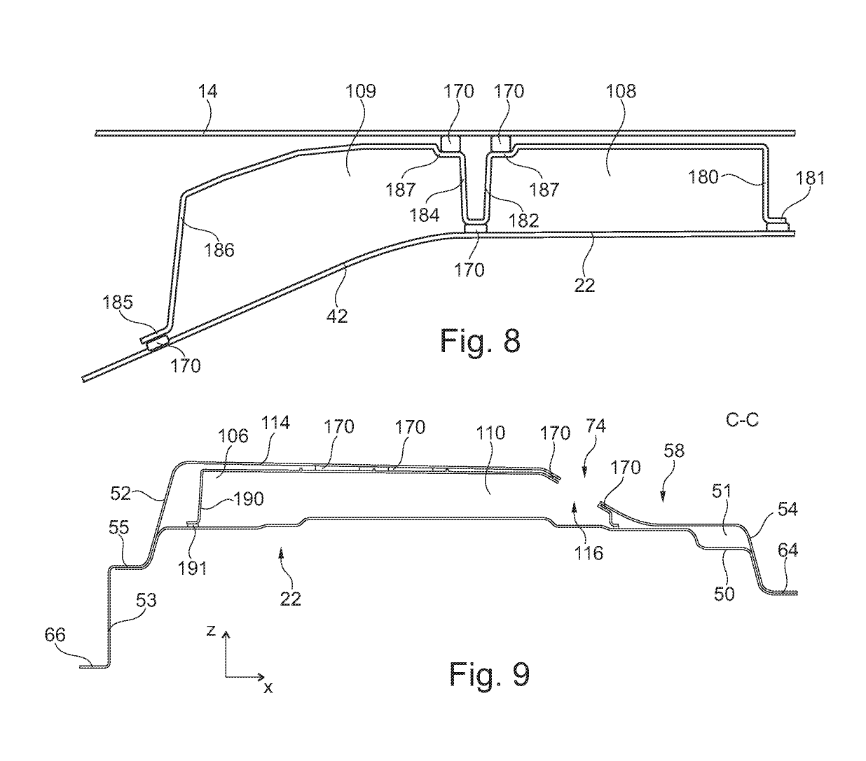

In the cross section B-B according to FIG. 7, two duct portions 108, 109 extending directly next to one another and parallel to one another and substantially in vehicle longitudinal direction (x) are shown, which likewise support themselves on the lower side of the seat connection portion 14 and on the upper side of the cross member structure 22. As is shown in the enlarged representation in FIG. 8, the duct portion 109 located outside comprises an outer side wall 186 and an inner side wall 184, each of which, facing downwards towards the cross member structure 22, are connected to the cross member structure 22 in a sealing manner by means of a seal 170 which is generally formed as adhesive.

In this respect, the outer side wall 186 merges into a flange 185 obliquely projecting downwards. The duct portion 108 which is spaced there from in vehicle transverse direction (y) comprises an outer side wall 182 and a side wall 180 directed towards the vehicle center, which via a flange 181 generally merges unitarily into the inner reinforcement portion 120 shown in FIG. 2. In the transition region between the side walls 182, 184, the duct portions 108, 109, each projected towards the bottom to the cross member structure 22 located below and towards the top to the seat connection portion 14 located above, in particular glued.

Upwardly adjoining the side walls 182, 184, trough-like shoulders 187 are provided, which serve for accommodating a seal 170 or a corresponding adhesive.

In the cross-sectional representation according to FIG. 9 it is shown, furthermore, that the front duct portion 106 of the reinforcement element 102 is structurally connected to the cross member structure 22, in particular glued, via front side wall 190 and a flange 191 projecting there from towards the front. The duct portion 106 hereby merges against the travelling direction 2 into a duct portion 110 projecting to the back, which with its outlet opening 116 projecting obliquely upwards and obliquely to the back, comes to lie substantially covering or overlapping the through-opening 74 in the region of the trough 58 of the seat connection portion 14.

The flange or flange portion 191 indicated in FIG. 9 and the flange portion 181, 185 as shown in FIG. 8, generally merge unitarily into one another and form a circumferential flange, by means of which the duct portions 104, 108 and 109 can be sealed off with respect to the cross member structure 22. The reinforcement element 102 assigned to the right vehicle side advantageously comprises a circumferential flange which is formed largely identically therewith, which seals off the duct portion 106 and the duct portions 110, 111 with respect to the cross member structure 22, generally with the help of a sealing material, in particular a thermally activatable adhesive.

At the rear end of the floor structure 1 facing away from the travelling direction 2, a further hollow profile portion 51 is additionally shown, which is formed by a transverse profile portion 50 of the cross member structure 22 formed approximately L-shaped in cross section and by a shaping of the seat connection portion 14 corresponding therewith in the transition region to a rear cheek 54 which obliquely drops downwards and ends in a horizontal flange.

Deviating from the configuration shown in the present FIGS. 1 to 9, a one-piece reinforcement element can also be implemented instead of two reinforcement elements 100, 102, which largely completely fills out the entire intermediate space 101 between seat connection portion 14 and cross member structure 22. It is also conceivable to divide the reinforcement elements 100, 102 shown here into individual structurally separated portions, which can each be connected to the adjoining floor structure components independently of one another, for example to the floor panel 10, its seat connection portion 14, the cross member structure 22 and/or to the longitudinal structure 18, 20.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A floor structure of a motor vehicle body having a floor panel and having a support structure provided below the floor panel, comprising:
two longitudinal structures spaced from one another in vehicle transverse direction; and
at least one cross member structure extending in vehicle transverse direction that interconnects the two longitudinal structures,
wherein in an intermediate space between the floor panel and the cross member structure at least one reinforcement element of plastic is arranged.

2. The floor structure according to claim 1, wherein the at least one reinforcement element is connected to the floor panel.

3. The floor structure according to claim 1, wherein the at least one reinforcement element is connected to the cross member structure.

4. The floor structure according to claim 1, wherein the at least one reinforcement element comprises a plurality of reinforcement ribs, which adjoin at least one of the floor panel and the cross member structure.

5. The floor structure according to claim 4, wherein at least some of the reinforcement ribs at their end portion face the floor panel.

6. The floor structure according to claim 5, wherein the cross member structure comprises at least one support flange.

7. The floor structure according to claim 6, wherein some of the reinforcement ribs in rib longitudinal direction are connected to at least one of the floor panel and the cross member structure in a force-fitting or materially bonded manner.

8. The floor structure according to claim 7, wherein along the support flange of at least one reinforcement rib a thermally activatable adhesive is arranged.

9. The floor structure according to claim 8, wherein the at least one reinforcement element comprises at least one air-conducting duct portion.

10. The floor structure according to claim 9, wherein the duct portion comprises a substantially U-profile-like cross section or a substantially V-profile-like cross section, which is closed off in a sealing manner by a portion of the floor panel or of the cross member structure adjoining thereon.

11. The floor structure according to claim 10, wherein the duct portion comprises at least one air inlet opening facing upwards to the floor panel and at least one air outlet opening spaced there from in vehicle longitudinal direction.

12. The floor structure according to claim 11, wherein the at least one air inlet opening with respect to the vehicle transverse direction is provided approximately in the middle between the longitudinal structures and the at least one air outlet opening is arranged laterally offset to the outside thereto.

13. The floor structure according to claim 12, wherein the floor panel and the cross member structure with respect to the vehicle vertical direction adjoin the longitudinal structure spaced from one another and the at least one reinforcement element supports itself with a lateral continuation in vehicle transverse direction on the longitudinal structure.

14. The floor structure according to claim 13, wherein the floor panel comprises a seat connection portion formed elevated with respect to a front foot well portion and the cross member structure comprises a one-piece areal structure corresponding to the total area of the seat connection portion.

15. The floor structure according to claim 14, wherein the at least one reinforcement element is formed as a single part of multiple parts almost completely fills out the intermediate space formed by a seat connection portion of the floor panel and by the cross member structure.

16. A motor vehicle, comprising:
a body; and
a floor structure of the body having a floor panel and having a support structure provided below the floor panel, the floor structure including two longitudinal structures spaced from one another in vehicle transverse direction, and at least one cross member structure extending in vehicle transverse direction that interconnects the two longitudinal structures,
wherein in an intermediate space between the floor panel and the cross member structure at least one reinforcement element of plastic is arranged and the at least one reinforcement element is connected to the floor panel.

17. The motor vehicle according to claim 16, wherein the at least one reinforcement element is connected to the cross member structure.

18. The motor vehicle according to claim 16, wherein the at least one reinforcement element comprises a plurality of reinforcement ribs, which adjoin at least one of the floor panel and the cross member structure.

19. The motor vehicle according to claim 18, wherein at least some of the reinforcement ribs at their end portion faces at least one of the floor panel.

20. The motor vehicle according to claim 19, wherein some of the reinforcement ribs in rib longitudinal direction are connected to at least one of the floor panel and the cross member structure in a force-fitting or materially bonded manner.
